(19) United States
(12) Patent Application Publication
(10) Pub. No.: US 2016/0201251 A1
(43) Pub. Date: Jul. 14, 2016

(54) DOOR-OPENING INDICATOR FOR DRUM WASHING MACHINE AND DOOR-OPENING CONTROL METHOD THEREFOR

(71) Applicants: HAIER GROUP CORPORATION, Qingdao (CN); QINGDAO HAIER WASHING MACHINE CO., LTD., Qingdao (CN)

(72) Inventors: Huacheng ZHANG, Qingdao (CN); Zeheng LI, Qingdao (CN); Xiaojie PI, Qingdao (CN); Yunfeng HE, Qingdao (CN)

(21) Appl. No.: 15/043,906

(22) Filed: Feb. 15, 2016

Related U.S. Application Data
(63) Continuation of application No. PCT/CN2013/090089, filed on Dec. 20, 2013.

(30) Foreign Application Priority Data
Aug. 16, 2013 (CN) 201310359520.7

(51) Int. Cl. D06F 39/14; G05B 15/02

(52) U.S. Cl. CPC D06F 39/14; G05B 15/02

(57) ABSTRACT

Disclosed are a door-opening indicator for a drum washing machine and a control method therefor. A door body is provided with a door lock for locking and unlocking the door body that is controlled by a computer programmable controller of the washing machine. The door-opening indicator is provided on the door body of the drum washing machine and/or on the front surface of the washing machine and includes a touch sensing device and a colour-changeable indicator lamp set that are connected to the computer programmable controller. The touch sensing device includes a touch area and an opening/closing sensing device. The touch sensing device detects a touch signal and transmits the signal to the computer programmable controller; and the computer programmable controller directly controls the opening/closing of the door body and controls the indicator lamp set to change colours according to the change in washing state.

### CROSS-REFERENCE TO RELATED APPLICATIONS

This application is a continuation application of International Patent Application No. PCT/CN2013/090089, filed Dec. 20, 2013, which itself claims the priority to Chinese Patent Application No. 201310359520.7, filed Aug. 16, 2013 in the State Intellectual Property Office of P.R. China, which are hereby incorporated herein in their entireties by reference.

### FIELD OF THE INVENTION

The present invention relates generally to the field of household appliance, and more particularly to a door-opening indicator for drum washing machine and a door-opening control method therefor.

### BACKGROUND OF THE INVENTION

Generally, the drum washing machine is a device that can clean washings, that is to say, it can remove stains attached to clothes, bed products and the like through washing, rinsing and dewatering processes by using the action of detergent and water.

To this end, a door body where the washings are picked and placed is mounted on the washing machine. In the drum washing machine, the above door body is generally mounted to the front, the door of the drum washing machine is mounted with a switch, and the function of the switch is that the door can be locked in the process of driving of the drum washing machine, to prevent water inside the washing machine from flowing out due to opening of the door.

The switch is a device that can lock or unlock the door of the drum washing machine, the door switch locks or unlocks a hook mounted to the door according to a control signal of a control portion, and in the case that the door switch is in a power-off situation, the user can open or close the door at will.

On the other hand, when the existing drum washing machine is in a drive state, the door switch will switch on, so that the door is kept in a locked state, and when the power supply on the drum washing machine is cut off or the drum washing machine is switched to a pause state, the door switch will be switched to an unlock state, so that the door is in an openable state.

However, the existing drum washing machine has the following problems.

The user, in the process of using the washing machine, often needs to open or close the door of the washing machine, as the door of the drum washing machine is disposed in the front, in order to prevent that the water in the drum flows out and the temperature in the drum is too higher during drying and to prevent hot air scalding men, door opening is not allowed. However, there is no prompt to instruct the user how to open the door and when to open the door. The user is confused in use.

Currently, the door of the drum washing machine is not allowed to be opened in the washing process, only the “start/pause” button on the front control panel of the washing machine can be pressed, and the computer program controller can release the door lock when judging that the door can be opened. However, generally, the user does not know that without seeing the instructions, which often results in that the user does not know where to start when he is to open the door. The existing washing machine cannot provide a relatively clear door-opening time and a door-opening method.

### SUMMARY OF THE INVENTION

An objective of the present invention is to provide a door-opening indicator that facilitates users to judge whether a door body is openable and a method for opening a door body.

To achieve the foregoing objective, a technical solution adopted in the present invention is:

A door-opening indicator for a drum washing machine, wherein a door body is provided with a door lock that locks and unlocks the door body controlled by a washing machine computer program controller, the door-opening indicator is disposed on the door body of the drum washing machine and/or a front portion of the washing machine, the door-opening indicator includes a touch sensor connected with the washing machine computer program controller and a color-changeable indicator lamp set, the touch sensor includes a touch region and an opening and closing sensor, the touch sensor detects a touch signal and transmits the signal to the washing machine computer program controller, the washing machine computer program controller directly controls opening and closing of the door body and controls the indicator lamp set to change color according to changes of a washing state.

The touch sensor and the color-changeable indicator lamp set are respectively disposed on the door body of the washing machine and the front portion of the washing machine, or the touch sensor and the color-changeable indicator lamp set are all disposed on the door body of the washing machine, or are disposed on the front portion of the washing machine.

The touch region and the opening and closing sensor of the touch sensor are disposed on the door body of the washing machine, and the color-changeable indicator lamp set is disposed on the front portion of the washing machine; or the touch region, the opening and closing sensor and the color-changeable indicator lamp set are all disposed on the door body of the washing machine, and preferably, the color-changeable indicator lamp set is disposed adjacent to or around the touch region.

The touch region, the opening and closing sensor and the color-changeable indicator lamp set are all disposed on a ring-like decorative box of the door body, preferably, the color-changeable indicator lamp set is disposed around the touch region, and more preferably, the color-changeable indicator lamp set is disposed on the touch region.

The door-opening indicator is disposed on the door body, the door-opening indicator is connected to the computer program controller through a cable, and the wiring direction of the cable is through a hinge along a gap between a door body window screen and a viewing window and then connected to the computer program controller along the housing of the washing machine.

The touch region is capacitive sensing or resistive sensing or optical sensing, the computer program controller judges whether the door body can be opened according to a washing state of the washing machine, then controls the door lock and indicator lamp set, maintains the door lock in a locked or unlocked state, and maintains or changes the color of the indicator lamp, and preferably, the door lock is an electromagnetic door lock automatically popping up.

A door-opening control method for the drum washing machine, including the following steps:

1) touching, by a user, the touch region of the touch sensor;

2) detecting, by the touch sensor, a touch signal, and transmitting the signal to the washing machine computer program controller; and

3) directly controlling, by the washing machine computer program controller, opening and closing of the door body according to the change of the washing state, and controlling the indicator lamp set of the door-opening indicator to display different colors.

When the washing machine is in a use state, the user directly touches the touch region of the touch sensor without pressing a start/pause button on the control panel.

The washing machine computer program controller judges according to the washing state that the current door body is at least in two states, an openable state and an unopenable state, sends a corresponding instruction of controlling the door lock on the door body, and controls the lamp set to display colors of the corresponding at least two states, and preferably, the washing machine computer program controller judges according to the washing state that the current door body is at least in three states, an opened state, an openable state and an unopenable state, sends a corresponding instruction of controlling the door lock on the door body, and controls the lamp set to display at least three colors of the corresponding at least three states.

The computer program controller of the washing machine controls opening and closing of the door lock of the washing machine according to the washing state of the washing machine; at the same time, the indicator lamp set is controlled to change the color to indicate the state of the door lock and prompt the user whether the door body of the washing machine can be opened; the change of the color of the indicator lamp set is divided into at least three gears, which are respectively set as colors A1, A2 and A3 according to opened, openable and unopenable states of the door body. The A1, A2 and A3 are RGB-format colors, changes of the RGB colors are controlled by the computer program controller, and chromatic aberrations CV of the A1, A2 and A3 are all set to be greater than 20.

The method in which the washing machine computer program controller judges the openable state of the current door body according to the washing state of the washing machine includes: after the washing machine completes washings, or the user touches a door-open button, as long as the washing machine meets a state that stalling of the motor is lower than a certain frequency value or the water level in the drum is lower than a certain value, or for a washing machine having a heating or drying function, the temperature in the drum is lower than a certain temperature value, the door body of the washing machine is in an openable state; and

the method in which the washing machine computer program controller judges the unopenable state of the current door body according to the washing state of the washing machine includes: when the washing machine is in a state that the motor rotates at a high speed or the water level in the drum is higher than a certain value, the temperature in the drum is higher than a certain temperature value, the door body of the washing machine is unopenable.

The washing machine computer program controller controls the indicator lamp set to change the color to display the working state of the washing machine, wherein the washing flow state of the washing machine includes one of water supply, washing, rinsing, drainage, spin-dry, drying and pause states or a combination thereof.

The present invention has the following beneficial effects:

1. The present invention adopts setting of a lamp set, making it convenient for users to judge whether the door body is in an openable state and instructing the users when to open the door, which solves the user's confusion in use, and the washing machine is beautiful, which increases diversity.

2. The touch sensor of the present invention directly controls opening of the door body, which changes the mechanical opening manner and avoids the phenomenon that the strength is great and damages the door body.

3. The present invention controls door opening in a touch sensing manner, which can better guide the users to operate, strengthen the man-machine dialogue, and is easy to operate, and touch operations are more modernized.

4. The indicator lamp set of the present invention can display the state of the washing machine, so that the users can clearly grasp the state of the washing machine through the change of the color of the indicator lamp set, and the display is more intuitive.

### BRIEF DESCRIPTION OF THE DRAWINGS

FIG. 1 is a flow chart of a door-opening control method for a drum washing machine according to the present invention.

FIG. 2 is a schematic diagram of positions of an indicator lamp set and a touch sensor in a door-opening indicator for a drum washing machine according to the present invention.

FIG. 3 is a connection diagram of a door-opening control signal of a drum washing machine according to the present invention.

FIG. 4 is a schematic structural diagram of a door-opening indicator for a drum washing machine according to the present invention.

FIG. 5 is a schematic diagram of positions of an indicator lamp set and a touch sensor in a door-opening indicator for a drum washing machine according to the present invention.

FIG. 6 is a schematic diagram of positions of an indicator lamp set and a touch sensor in a door-opening indicator for a drum washing machine according to the present invention.

FIG. 7 is a schematic diagram of positions of an indicator lamp set and a touch sensor in a door-opening indicator for a drum washing machine according to the present invention.

FIG. 8 is a schematic diagram of positions of an indicator lamp set and a touch sensor in a door-opening indicator for a drum washing machine according to the present invention.

FIG. 9 is a schematic diagram of positions of an indicator lamp set and a touch sensor in a door-opening indicator for a drum washing machine according to the present invention.

Numeral references of components: 1—washing machine computer program controller, 2—cable, 3—touch sensor, 4—washing machine door body, 5—door body decorative box, 6—light guide region, 7—indicator lamp set, 8—opening and closing sensor, 9—touch region, 10—LED lamp, and 11—front panel.

### DETAILED DESCRIPTION OF THE INVENTION

A door-opening device and a door-opening method for a drum washing machine of the present invention are described below in detail with reference to the accompanying drawings.

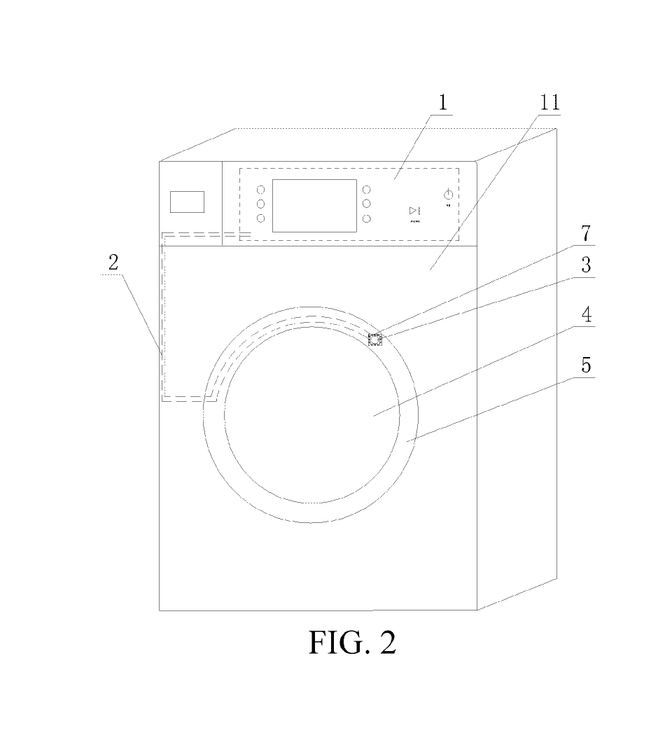

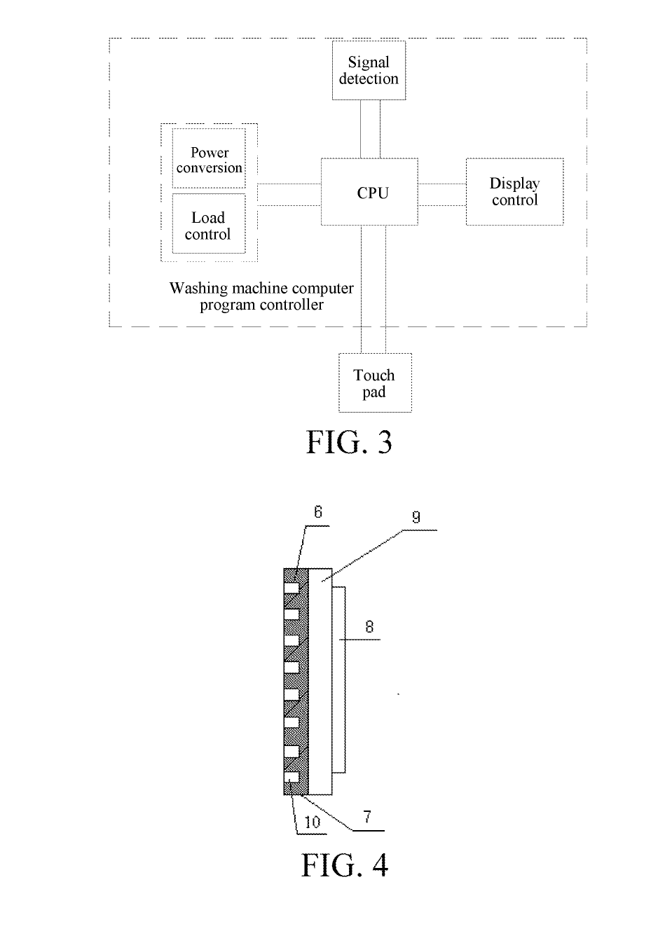

As shown in FIG. 2, a door-opening indicator for a drum washing machine is disposed on a door body 4 of the drum washing machine, the door body 4 is provided with a door lock that locks and unlocks the door body controlled by a computer program controller 1, the door-opening indicator includes a touch sensor 3 connected with the washing machine computer program controller 1 and a color-changeable indicator lamp set 7, the touch sensor 3 includes a touch region 9 and an opening and closing sensor 8, the touch sensor 3 detects a touch signal and transmits the signal to the washing machine computer program controller 1, the washing machine computer program controller 1 directly controls opening and closing of the door body and controls the indicator lamp set 7 to change color according to changes of a washing state, so that the users can directly and conveniently see what state the washing machine door body 4 is in, for example, it displays with different colors that the door body 4 of the washing machine is in an opened stated, an openable state and opens the door body 4 of the washing machine or the door body 4 of the washing machine is in an unopenable state.

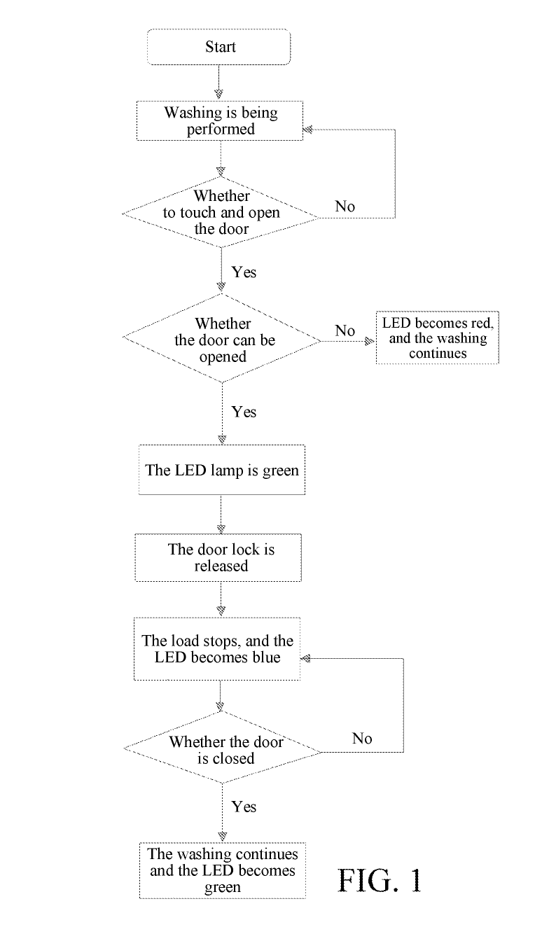

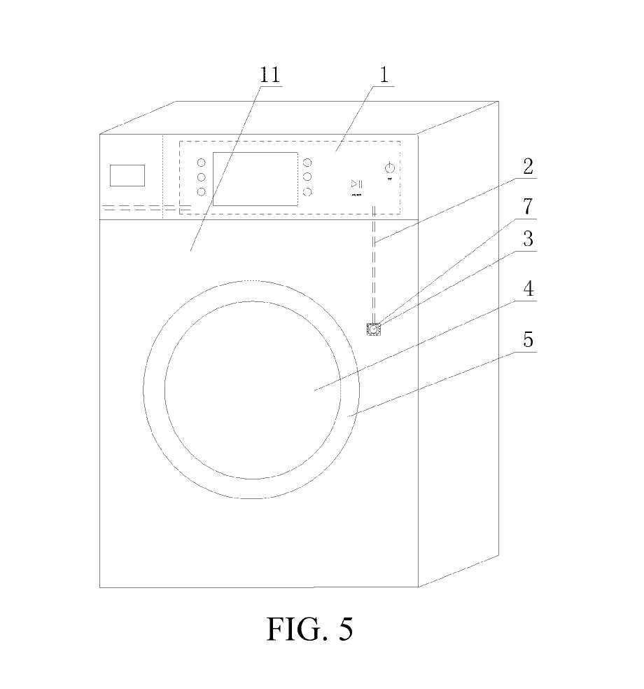

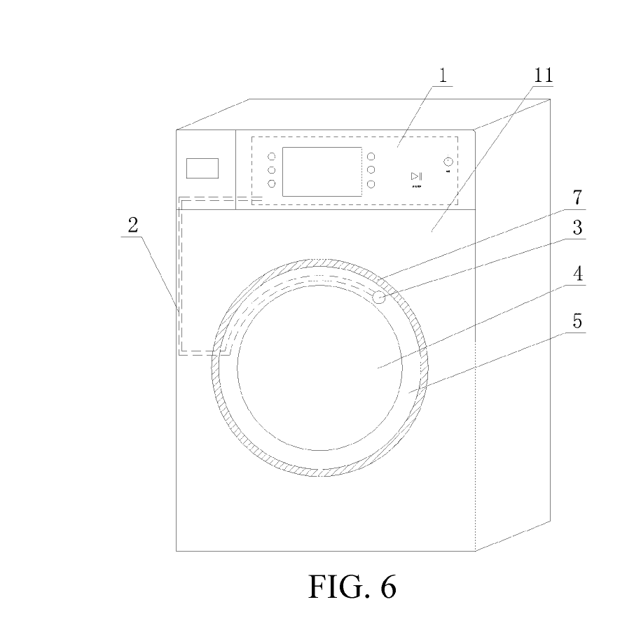

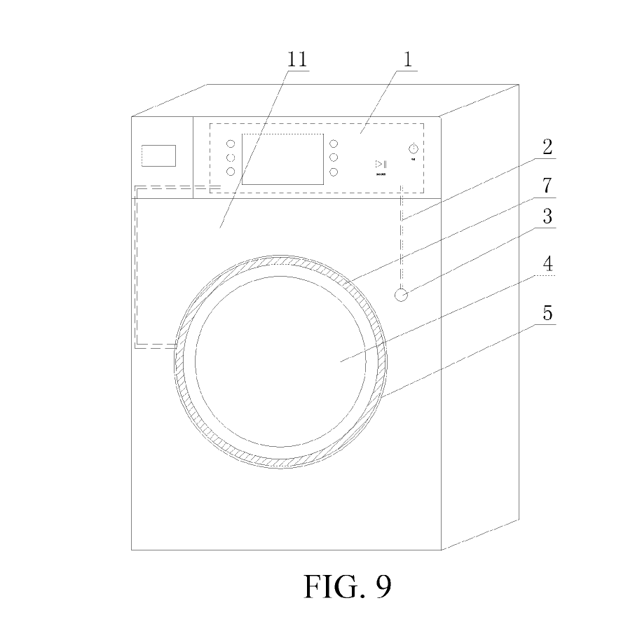

As shown in FIG. 1, in the present invention, the touch region 9 and the opening and closing sensor 8 of the touch sensor 3 and the color-changeable indicator lamp set 7 are all disposed on the door body 4 of the washing machine; as shown in FIG. 5, in the present invention, the touch region 9 and the opening and closing sensor 8 of the touch sensor 3 and the color-changeable indicator lamp set 7 are all disposed on the front portion 11 of the washing machine; it is also feasible to respectively dispose the touch region 9 and the opening and closing sensor 8 of the touch sensor 3 and the color-changeable indicator lamp set 7 on the door body 4 of the washing machine or the front portion 11 of the washing machine includes a control panel portion; as shown in FIG. 6, in one embodiment of the present invention, the touch region 9 and the opening and closing sensor 8 of the touch sensor 3 are disposed on the door body 4 of the washing machine, and the color-changeable indicator lamp set 7 is disposed on the front portion of the washing machine, preferably around the door body 4; or, on the contrary, as shown in FIG. 9, the color-changeable indicator lamp set is disposed on the door body of the washing machine, and the touch region 9 and the opening and closing sensor 8 of the touch sensor 3 are disposed on the front portion 11 of the washing machine.

As an option, in the present invention, the touch region 9, the opening and closing sensor 8 and the color-changeable indicator lamp set 7 are all disposed on the front portion 11 of the washing machine, which, in this case, are preferably disposed close to the door body 4 (refer to FIG. 5).

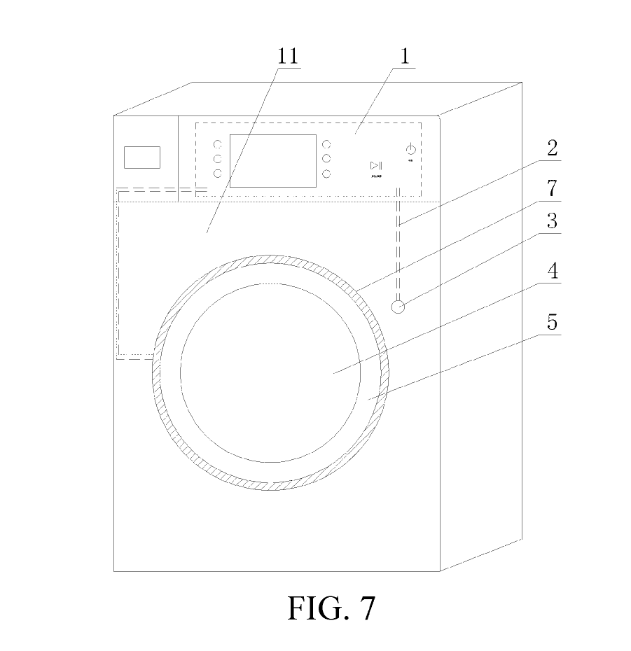

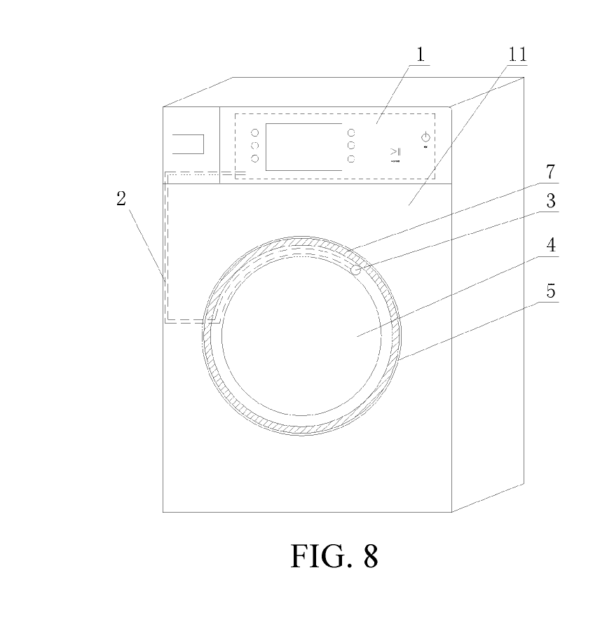

In the present invention, the color-changeable indicator lamp set 7 may be disposed on the door body of the washing machine or on the front portion 11 of the washing machine, in one embodiment of the present invention, the color-changeable indicator lamp set 7 is disposed on the front portion 11 of the washing machine and disposed around the door body (refer to FIG. 6 and FIG. 7), when the color-changeable indicator lamp set 7 is disposed on the door body 4 of the washing machine, the color-changeable indicator lamp set 7 is disposed on a ring-like decorative box 5 of the door body (refer to FIG. 8 and FIG. 9), which can give a definite and clear indication to consumers; generally, preferably, the color-changeable indicator lamp set is disposed adjacent to or around the touch region, in this way, the color-changeable indicator lamp set 7 is disposed on or around the touch region 9 (refer to FIG. 2 and FIG. 5), and if the color-changeable indicator lamp set 7 is disposed on the touch region, it can facilitate mounting.

According to the present invention, the touch region 9 and the opening and closing sensor 8 are connected to the computer program controller 1 through a cable 2, and the wiring direction of the cable 2 is through a hinge along a gap between a door body window screen and a viewing window and then connected to the computer program controller 1 along the housing of the washing machine. The touch region 9 is capacitive sensing or resistive sensing or optical sensing, the computer program controller 1 judges whether the door body can be opened according to a washing state of the washing machine, then controls the door lock and indicator lamp set, maintains the door lock in a locked or unlocked state, and maintains or changes the color of the indicator lamp.

As shown in FIG. 4, in one embodiment of the present invention, the touch sensor 3 is provided with an opening and closing sensor 8, the opening and closing sensor 8 includes a PCB board, the PCB board is provided with a touch detection circuit, an indicator lamp set 7 is disposed around the PCB board, the touch sensor 3 controls opening and closing of the door body of the washing machine through the computer program controller 1, and the color of the indicator lamp set 7 changes the color through the computer program controller according to the washing state to indicate whether the user can open the door body now and controls opening of the door body according to the running state of the washing machine; in one embodiment of the present invention, the color of the indicator lamp set changes the color through the computer program controller 1 according to the washing state to indicate the user the working state of the washing machine.

As shown in FIG. 2, when the door-opening indicator is disposed on the door body 4, the door-opening indicator is connected to the computer program controller through a cable, the cable is connected to a hinge through a gap between a door body window screen and a viewing window and then connected to the computer program controller 1 along the housing of the washing machine. The indicator lamp set 7 consists of a color-changeable LED lamp 10 and a light guide region 6 covering the LED lamp 10, and the light guide region 6 is a transparent or semitransparent lampshade surrounding the touch region (refer to FIG. 4).

The cable 2 that supplies power for the touch sensor 3 connects the touch sensor and the indicator lamp set at the same time, and transmits a user's door open signal to the computer program controller 1, and the computer program controller 1 judges according to the washing state of the washing machine whether the door body has been opened, then sends a signal to the door lock and the indicator lamp, maintains the door lock in a locked or unlocked state, and maintains or changes the color of the indicator lamp.

In the present invention, after the computer program controller 1 receives a touch signal, the computer program controller 1 judges according to the washing state of the washing machine that the current door body 4 is at least in three states, an opened state, an openable state and an unopenable state, and controls the indicator lamp set 7 to display different colors of the corresponding at least three states; for example, the computer program controller detects whether the current door body is in an openable state, if yes, the computer program controller sends a signal to the door lock, controls the door body to unlock, the door body is opened, and the indicator lamp set is controlled to display a certain color, for example, green.

In the present invention, the washing machine computer program controller 1 directly controls opening and closing of the door body 4 according to the change of the washing state, and controls the indicator lamp set 7 to display different colors; when the user presses down the touch region of the touch sensor, the opening and closing sensor receives a touch sensing signal, and the washing machine computer program controller 1 sends a signal to the door lock of the door body 4 of the washing machine according to the washing state of the washing machine, to control locking and unlocking of the door lock; at the same time, a signal is sent to the indicator lamp, and the color of the indicator lamp is changed to indicate the user whether the door body 4 has been in an opened state or whether the door body 4 of the washing machine can be opened; wherein, when the washing machine is in a state that the door body has been opened, the indicator lamp displays a first color; after the washing machine completes washings, or the user touches a door-open button, as long as the washing machine meets a state that stalling of the motor is lower than a certain frequency value or the water level in the drum is lower than a certain value, or for a washing machine having a heating or drying function, the temperature in the drum is lower than a certain temperature value, the door body 4 of the washing machine is in an openable state; and

the method in which the washing machine computer program controller 1 judges the unopenable state of the current door body 4 according to the washing state of the washing machine includes: when the washing machine is in a state that the motor rotates at a high speed or the water level in the drum is higher than a certain value, the temperature in the drum is higher than a certain temperature value, the door body 4 of the washing machine is unopenable.

Even if the user presses down the touch region 9 of the touch sensor, the door body is still in the locked state and cannot be opened, at this point, the indicator lamp displays a third color, for example, it is feasible to set the first color indicating that the door body has been opened as blue, the second color indicating that the door body 4 of the washing machine can be opened and the third color indicating that the door body 4 of the washing machine cannot be opened; certainly, indication of the colors can be set arbitrarily, as long as the consumers' habits are met. Certainly, the same color may be set for that the door body is openable and has been opened, for example, both are blue.

In the present invention, the indicator lamp set 7 is directly electrically connected with the washing machine computer program computer 1, the washing machine computer program computer 1 may also control the indicator lamp set 7 to change the color to display the working state of the washing machine, that is, the indicator lamp set 7 indicates the washing flow state with different colors, wherein the washing flow state of the washing machine includes, but is not limited to, various working states such as water supply, washing, rinsing, drainage, spin-dry, drying and pause, for example, water supply is yellow, washing is apple green, rinsing is pea green, drainage is golden, spin-dry is purple, drying is orange, pause is brown and the like; as the indicator lamp set 7 of the present invention includes several lamp strips, and the working state of the washing machine can be further displayed through the change of the strength of the pipeline of the lamp strips, for example, strong washing, gentle, high-speed spin-dry or the drying temperature and the like, to provide the user with further convenience.

Further, the present invention makes the lamp strips in the indicator lamp set 7 present different functions, for example, some lamp strips display the color of the door body 4, and in this way, when the user opens the title of the washing machine, he can also directly understand the working state of the washing machine, to further facilitate the user.

FIG. 1 illustrates a door-opening control method for a drum washing machine having the door-opening indicator of the present invention, the method including: when the washing machine is in a working or stop state, the user touches the touch region 9 of the touch sensor 3, the touch sensor detects a touch signal and transmits the signal to the washing machine computer program controller 1; the washing machine computer program controller 1 directly controls opening and closing of the door body 4 according to the working state of the washing machine, and controls the indicator lamp set 7 to display different colors to facilitate the users to directly obtain information indicating what state the door body 4 is in.

Different from the prior art, when the washing machine is in a use state, the user can directly the touch region 9 of the touch sensor to control opening of the door body 4 of the washing machine without pressing the start/pause button on the control panel.

The washing machine computer program controller 1 of the present invention sends a signal to the door lock of the washing machine according to the washing state of the washing machine, to control locking and unlocking of the door lock; at the same time, a signal is sent to the indicator lamp, and the color of the indicator lamp is changed to indicate the user whether the door body of the washing machine can be opened; and a touch signal detected by touching the button is used to control opening of the door body.

After the machine computer program controller 1 receives the detected touch signal, the machine computer program controller 1 judges according to the washing state of the washing machine that the current door body is at least in three states, an opened state, an openable state and an unopenable state, and controls the lamp set to display different colors of the corresponding at least three states; for example, the computer program controller detects whether the current door body is in an openable state, if yes, the computer program controller sends a signal to the door lock, controls the door body to unlock, the door body is opened, and the indicator lamp set is controlled to display a certain color, for example, green.

The method in which the washing machine computer program controller 1 judges the openable state of the current door body 4 according to the washing state of the washing machine includes:

after the washing machine completes washings, or the user touches a door-open button, as long as the washing machine meets a state that stalling of the motor is lower than a certain frequency value or the water level in the drum is lower than a certain value, or for a washing machine having a heating or drying function, the temperature in the drum is lower than a certain temperature value, the door body 4 of the washing machine is in an openable state; and

the method in which the washing machine computer program controller 1 judges the unopenable state of the current door body 4 according to the washing state of the washing machine includes: when the washing machine is in a state that the motor rotates at a high speed or the water level in the drum is higher than a certain value, the temperature in the drum is higher than a certain temperature value, the door body 4 of the washing machine is unopenable.

The touch region 9 of the present invention is capacitive sensing or resistive sensing or optical sensing, for example, infrared sensing; after the touch sensor senses the touch signal, the cable transmits a door-open indication signal to the computer program controller, the computer program controller detects whether the current door body is in an openable state, if yes, the computer program controller sends a signal to the door lock to control the door body to be unlocked, and the door body is opened.

The door lock is an electromagnetic door lock automatically popping up.

In the present invention, for indicating the open state of the door body 4, the change of the color of the indicator lamp set 7 is divided into at least three gears, which are respectively set as colors A1, A2 and A3 according to opened, openable and unopenable states of the door body. The A1, A2 and A3 are RGB-format colors, changes of the RGB colors are controlled by the computer program controller, and chromatic aberrations CV of the A1, A2 and A3 are all set to be greater than 20, to facilitate the user to identify the change of the color and accurately judge the state of the washing machine door body.

A terminal block connected with the cable is disposed in the touch region, which transmits signals and provides power.

As shown in FIG. 4, in the present invention, a touch region is disposed on a door of the washing machine, and around the touch region is light for guiding. If the region is touched, the door of the washing machine can be opened. The light around the touch region may change the color correspondingly according to the washing state of the washing machine and whether the door can be opened, to guide the user whether the door can be opened.

In the touch region, a touch pad is mounted to the back of the panel of the door of the washing machine, the touch pad is provided with a capacitive touch button, a signal lamp and a light guide strip, and the power of the touch pad is provided by the computer program controller of the washing machine, which are connected through wires. A connecting line is led out from the front control panel of the washing machine, is fixed, at a door hinge, to a gap between glass of a door window screen and a viewing window, and is connected with the touch pad. In this embodiment, the signal indicator lamp is an LED lamp, the LED lamp is an RGB indicator lamp, and when the door of the washing machine can be opened, the computer program controller drives the LED lamp to indicate green; when the door of the washing machine cannot be opened, the computer program controller drives the LED lamp to indicate red; after the door has been opened, the computer program controller drives the LED lamp to indicate blue.

As stated above, similar technical solutions can be derived in combination with the drawings and the contents of solutions given in the embodiments. However, any simple amendment, equivalent variation and modification made to the above embodiments according to the technical essence of the present invention without departing from contents of the technical solution of the present invention should all fall within the scope of the technical solution of the present invention.

What is claimed is:

1. A door-opening indicator for a drum washing machine, a door body being provided with a door lock that locks and unlocks the door body controlled by a washing machine computer program controller, and the door-opening indicator being disposed on the door body of the drum washing machine and/or a front portion of the washing machine, wherein the door-opening indicator comprises a touch sensor (3) connected with the washing machine computer program controller (1) and a color-changeable indicator lamp set (7), the touch sensor (3) comprises a touch region (9) and an opening and closing sensor (8), the touch sensor (3) detects a touch signal and transmits the signal to the washing machine computer program controller (1), the washing machine computer program controller (1) directly controls opening and closing of the door body and controls the indicator lamp set (7) to change color according to changes of a washing state.

2. The door-opening indicator for a drum washing machine according to claim 1, wherein the touch sensor (3) and the color-changeable indicator lamp set (7) are respectively disposed on the door body of the washing machine and the front portion (11) of the washing machine, or the touch sensor (3) and the color-changeable indicator lamp set (7) are all disposed on the door body (4) of the washing machine, or are disposed on the front portion (11) of the washing machine.

3. The door-opening indicator for a drum washing machine according to claim 1, wherein the touch region (9) and the opening and closing sensor (8) of the touch sensor (3) are disposed on the door body (4) of the washing machine, and the color-changeable indicator lamp set (7) is disposed on the front portion of the washing machine; or the touch region (9), the opening and closing sensor (8) and the color-changeable indicator lamp set (7) are all disposed on the door body (4) of the washing machine, and preferably, the color-changeable indicator lamp set (7) is disposed adjacent to or around the touch region (9).

4. The door-opening indicator for a drum washing machine according to claim 1, wherein the touch region (9), the opening and closing sensor (8) and the color-changeable indicator lamp set (7) are all disposed on a ring-like decorative box of the door body (4), preferably, the color-changeable indicator lamp set (7) is disposed around the touch region (9), and more preferably, the color-changeable indicator lamp set (7) is disposed on the touch region (9).

5. The door-opening indicator for a drum washing machine according to claim 1, wherein the door-opening indicator is disposed on the door body (4), the door-opening indicator is connected to the computer program controller (1) through a cable (2), and the wiring direction of the cable (2) is through a hinge along a gap between a door body window screen and a viewing window and then connected to the computer program controller (1) along the housing of the washing machine.

6. The door-opening indicator for a drum washing machine according to claim 1, wherein the touch region (9) is capacitive sensing or resistive sensing or optical sensing, the computer program controller (1) judges whether the door body can be opened according to a washing state of the washing machine, then controls the door lock and indicator lamp set, maintains the door lock in a locked or unlocked state, and maintains or changes the color of the indicator lamp, and preferably, the door lock is an electromagnetic door lock automatically popping up.

7. A door-opening control method for the drum washing machine according to claim 1, comprising the following steps:
1) touching, by a user, the touch region (9) of the touch sensor (3);
2) detecting, by the touch sensor, a touch signal, and transmitting the signal to the washing machine computer program controller (1); and
3) directly controlling, by the washing machine computer program controller (1), opening and closing of the door body (4) according to the change of the washing state, and controlling the indicator lamp set (7) of the door-opening indicator to display different colors.

8. The door-opening control method for the drum washing machine according to claim 7, wherein, when the washing machine is in a use state, the user directly touches the touch region of the touch sensor without pressing a start/pause button on the control panel.

9. The door-opening control method for the drum washing machine according to claim 8, wherein the washing machine computer program controller judges according to the washing state that the current door body is at least in two states, an openable state and an unopenable state, sends a corresponding instruction of controlling the door lock on the door body (4), and controls the lamp set to display colors of the corresponding at least two states, and preferably, the washing machine computer program controller judges according to the washing state that the current door body is at least in three states, an opened state, an openable state and an unopenable state, sends a corresponding instruction of controlling the door lock on the door body (4), and controls the lamp set to display at least three colors of the corresponding at least three states.

10. The door-opening control method for the drum washing machine according to claim 7, wherein the method in which the washing machine computer program controller (1) judges the openable state of the current door body (4) according to the washing state of the washing machine comprises: after the washing machine completes washings, or the user touches a door-open button, as long as the washing machine meets a state that stalling of the motor is lower than a certain frequency value or the water level in the drum is lower than a certain value, or for a washing machine having a heating or drying function, the temperature in the drum is lower than a certain temperature value, the door body (4) of the washing machine is in an openable state; and
wherein the method in which the washing machine computer program controller (1) judges the unopenable state of the current door body (4) according to the washing state of the washing machine comprises: when the washing machine is in a state that the motor rotates at a high speed or the water level in the drum is higher than a certain value, the temperature in the drum is higher than a certain temperature value, the door body (4) of the washing machine is unopenable.

11. The door-opening control method for the drum washing machine according to claim 7, wherein the washing machine computer program controller (1) controls the indicator lamp set (7) to change the color to display the working state of the washing machine, wherein the washing flow state of the washing machine comprises one of water supply, washing, rinsing, drainage, spin-dry, drying and pause states or a combination thereof.
